(19) United States
(12) Patent Application Publication
(10) Pub. No.: US 2014/0372841 A1
(43) Pub. Date: Dec. 18, 2014

(54) SYSTEM AND METHOD FOR PRESENTING A SERIES OF VIDEOS IN RESPONSE TO A SELECTION OF A PICTURE

(71) Applicant: Henner Mohr, Littleton, CO (US)

(72) Inventor: Henner Mohr, Littleton, CO (US)

(21) Appl. No.: 14/297,782

(22) Filed: Jun. 6, 2014

Related U.S. Application Data
(60) Provisional application No. 61/835,429, filed on Jun. 14, 2013.

(51) Int. Cl. G06F 17/30

(52) U.S. Cl. CPC G06F 17/30017
USPC 715/201

(57) ABSTRACT

Methods and apparatuses for displaying a sequence including an image and a video in a web browser are provided. More particularly, systems and methods to present a series of videos in response to a selection of a picture made by a user are provided. A user may select view a first image and select a thumbnail of a second image. One or more videos corresponding to a path existing between a node associated with the first image and a node associated with the second image may then be presented to the user. Following the last video, the second image may then be displayed to the user.

### CROSS-REFERENCE TO RELATED APPLICATIONS

This application claims the benefit of U.S. Provisional Patent Application Ser. No. 61/835,429, filed Jun. 14, 2013, and U.S. Provisional Patent Application Ser. No. 61/835,419, filed Jun. 14, 2013, the entire disclosures of which are hereby incorporated herein by reference.

### FIELD

Methods and systems for displaying a sequence including an image and a video in a web browser are provided. More particularly, systems and methods to present a series of videos in response to a selection of a picture made by a user are provided.

### BACKGROUND

Keeping pace with technology, the advertisement and marketing of real estate and other property has migrated from brochures, magazines, and/or flyers to specially created computer programs, websites, blogs, and the like which provide an individual with access and customized information relating to a property of interest. Furthermore, as the price of implementing various technological solutions decreases, the Internet is being used as part of an overall advertising and marketing strategy to reach more and more potential buyers using various devices, such as computers, mobile phones, and tablets. For example, dedicated businesses and/or services that sell property, both real property and personal property, typically provide a property listing accessible via the Internet using a web browser or application, such as an application or App. Such property listings generally include detailed information about the property and may include one or more pictures of the property. Listings containing various pictures of properties, showing one or more perspectives of the properties, are generally referred to as virtual tours.

Virtual tours generally provide an individual with additional visual information relating to a property. For example, conventional virtual tours may provide the ability for an individual to view various rooms within a home, vehicle, or otherwise and at various perspectives or angles. For instance, a user may be able to view various, images related to a kitchen, various images related to a bedroom, and various images related to a garage. However, transitions occurring between one or more images tend to be quick fades, dissolves, or image replacements and do not include other media types during the transition. Therefore, a transition that incorporates additional media types is needed.

### SUMMARY

Embodiments of the present invention provide a virtual tour having a realistic look and feel. That is, a system and method are provided that allow an individual, or user, to not only view static images of property, both real property and personal property, but also allow a user to view video, or moving images, along a path from one or more locations to another location. Detailed information about property is generally provided in text and/or image form. For example, prior to information about a home or dwelling being posted or available on an Internet site, the information must first be collected or gathered. Conventional information gathering techniques associate imagery and textual content with specific features and/or areas of a property. As one example, and in the context of real estate, one or more images of a room and additional information about the room, for example size and location information, may be gathered and provided to a user. When one or more images for a room are gathered, additional information differentiating the image must also be provided. For example, three images corresponding to a particular bedroom of a house may be acquired at different locations or at different perspectives showing one or more perspectives of the bedroom. Traditional techniques to differentiate the images include labeling each image with a generic location or node label. Thus, three images showing different perspectives and/or from three different locations may be labeled as node A, node B, and node C. In addition to acquiring images at each location, video from one node to another node is also acquired. One or more videos may then be presented and displayed to a user in response to the user's selection of the image.

In some embodiments, one or more nodes may be associated with a unique location in and/or around a property and each node may include an image or thumbnail representative of the node; a collection of nodes (e.g. an array of nodes) may correspond to a section, or unique partitioning of the property. Embodiments of the present invention may allow a user to interact with a virtual tour to view one or more videos associated with a collection of paths in response to a selection of an image.

As another example, real property, such as a house, may be partitioned into unique sections. As one non-limiting example, the house may have a section corresponding to a living room, a section corresponding to a kitchen, a section corresponding to a set of stairs, and a section corresponding to a basement. Each section may further include one or more nodes. Continuing with the above example, the living room may have one or more unique nodes located at various points throughout the living room; the kitchen may have one or more unique nodes located throughout the kitchen; the set of stairs may have one or more unique nodes located along the set of stars; and the basement may have one or more unique nodes located throughout the basement. Further, one or more nodes of each section may serve as transition nodes, or nodes that connect two or more sections together. Video corresponding to one or more paths, or tracks, between each node in a section is collected/recorded for all defined sections. Further, video corresponding to one or more paths, or tracks, between transition nodes connecting two or more sections together is collected/recorded. Additionally, at least one image for each node is also collected/recorded. Embodiments of the disclosed invention provide a system and method for presenting the one or more videos corresponding to the one or more paths to a user in response to a selection of an image. Embodiments consistent with the present invention then display the one or more videos, corresponding to the collection of paths, to a user.

In accordance with at least one embodiment of the present disclosure, a method for presenting a series of videos to a user is provided, the method comprising displaying a first image, receiving an indication associated with a selection of a second image to be displayed, displaying one or more videos based upon the received indication, and displaying a third image associated with the second image after the one or more videos have been displayed.

In accordance with further embodiments of the present disclosure, a method for presenting a series of videos to a user is provided, the method comprising providing a first image to a client device, receiving an indication associated with a selection of a second image to be displayed, generating a list containing one or more videos, wherein each video within the list containing the one or more videos corresponds to a path existing between a first node associated with the first image and a second node associated with the second image, providing the one or more videos to the client device based upon the generated list, and providing a third image corresponding to the second image to the client device.

In accordance with further embodiments of the present disclosure, a system for presenting a series of videos to a user is provided, the system comprising a device including: a communication interface, a processor, data storage, and a client application stored on the data storage, wherein the client application includes instructions that when executed by the processor, are operable to present a first image and a plurality of thumbnail images at a user output device, wherein the client application is operable to receive an indication associated with a selection of a first thumbnail image, wherein the client application is operable to display one or more videos corresponding to the received indication, and wherein the client application is operable to display a second image, wherein the second image is a larger image corresponding to the first thumbnail image.

Aspects of the present disclosure are thus directed toward a system and method for presenting a series of videos, such as videos corresponding to a collection of paths (e.g. array of paths), to a user in response to a selection of a picture or image from the user. Although the ensuing description may be directed to one or more examples pertaining to real property, it should be understood that the description and teachings herein may be applied to other types of property, such as tangible property, non-tangible property, virtual property, and the like. Therefore, the following description may be applicable to instances where video content is utilized to transition between two or more images.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. The database may be hosted within the communication server or on a separate server. Accordingly, the disclosure is considered to include a tangible storage medium and prior art-recognized equivalents and successor media, in which the software implementations of the present disclosure are stored.

Additional features and advantages of embodiments of the present invention will become more readily apparent from the following description, particularly when taken together with the accompanying drawings.

### BRIEF DESCRIPTION OF THE DRAWINGS

FIG. 1 depicts a first virtual tour system configuration in accordance with embodiments of the present invention;

FIG. 2 depicts an example layout including nodes and sections in accordance with embodiments of the present invention;

FIG. 3 depicts an example of a user interface in accordance with embodiments of the present disclosure;

FIG. 4 depicts an example image to video to image transition in accordance with embodiments of the present disclosure; and

FIG. 5 depicts a flowchart depicting a process in accordance with embodiments of the present invention.

### DETAILED DESCIPRTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

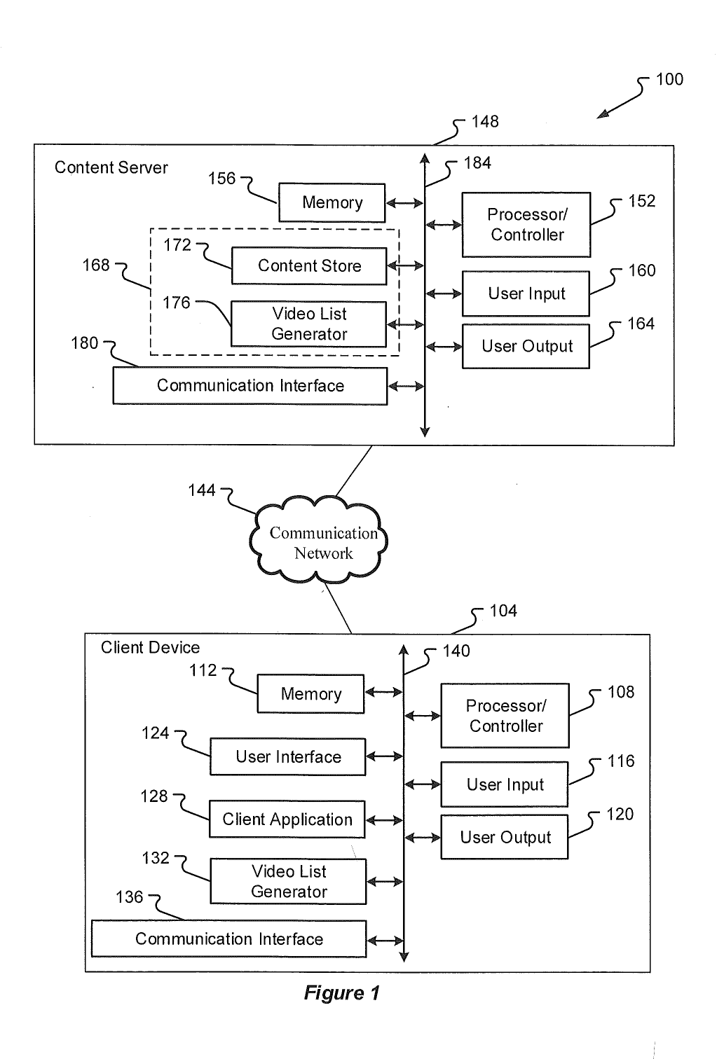

FIG. 1 shows an illustrative embodiment of a virtual tour system 100 in accordance with at least some embodiments of the present disclosure. The virtual tour system 100 may include one or more content servers 148 and one or more client devices 104. The virtual tour system 100, and components of system 100, may be a distributed system and, in some embodiments, comprises a communication network(s) 144 connecting one or more client devices 104 and one or more content servers 104.

The client device 1040 may comprise a general purpose computer, such as but not limited to a laptop or desktop personal computer, a tablet computer, a smart phone, or other device capable of communications over the communication network and capable of presenting content to an associated user. The client device 104 includes and/or executes a client application 128 in connection with the presentation of content, such as video content, to a user. Accordingly, the client application 128 may comprise application programming stored on or accessible to the client device 104, that is executed by or on behalf of the client device 104 in connection with the presentation of content. As one example, the client application 128 may comprise a web browser and cause to be displayed content, such as virtual tour information, video content, and property information, to a user via a user interface 124.

The content server 148 may include a general purpose computer or server computer. Moreover, the content server 148 may comprise one or more devices that perform functions in support of the generation of one or more trails and the presentation of video content comprising a virtual tour to a client device over the communication network. The content server 148 may include or implement a server application 168. The server application 168 may receive information associated with a virtual tour and provide content, from a content store 172, such as video content, to the client device 104.

In accordance with other embodiments, the content server 148 may perform or support administrative functions. For example, information pertaining to content provided to the client device 104 and/or presented by a client device 104 to an associated user, may be collected by the content server 148. Such information may be provided to an administration module. The administration module may perform functions related to associating one or more videos to a path and performing digital rights management functions with respect to items of content.

In some embodiments, the content server 148 and/or the client device 104 may include a processor/controller 108, 152 capable of executing program instructions. The processor/controller 108, 152 may include any general purpose programmable processor or controller for executing application programming. Alternatively, or in addition, the processor/controller 108, 152 may comprise an application specific integrated circuit (ASIC). The processor/controller 108, 152 generally functions to execute programming code that implements various functions performed by the associated content server 148 and/or client device 104. The processor/controller 152 of the content server 148 may operate to provide content, such as one or more videos, to a client device 104 such that a user may view the provided video(s) in response to a selection of a picture or image.

The content server 148 and/or the client device 104 may additionally include memory 112, 156. The memory 112, 156 may be used in connection with the execution of programming instructions by the processor/controller, and for the temporary or long term storage of data and/or program instructions. For example, the processor/controller 152, in conjunction with the memory 156 of the content server 148, may implement virtual tour applications, web services, and other functionality that is needed and accessed by the client device 104. The memory 156 of the content server 148 and the memory 112 of the client device 104 may comprise solid state memory that is resident, removable and/or remote in nature, such as DRAM and SDRAM. Moreover, the memory 112, 156 may comprise a plurality of discrete components of different types and/or a plurality of logical partitions. In accordance with still other embodiments, the memory 112, 156 comprises a non-transitory computer readable storage medium. Such a medium may take many forms, including but not limited to, non-volatile media, volatile media, and transmission media.

In addition, user input devices 116, 160 and user output devices 120, 164 may be provided and used in connection with the content server 148 and/or client device 104 respectively. For example, a user may enter information, or initiate a communication with the content server 148 by directing a web browser to a website provided, or served, by the web server by entering a website address or by clicking on a hyperlink associated with the website. Examples of user input devices 116, 160 include a keyboard, a numeric keypad, a touch screen, a microphone, scanner, and pointing device combined with a screen or other position encoder. Examples of user output devices 120, 164 include a display, a touch screen display, a speaker, and a printer. The content server 148 and/or the client device 104 also generally include a communication interface 136, 180 to allow for communication between the client device 104 and the content server 148. The communication interface 136, 180 may support 3G, 4G, cellular, WiFi, Bluetooth®, NFC, RS232, and RF and the like and generally provide the ability to communicate over the communication network 144.

The communication network 144 may be packet-switched and/or circuit-switched. An illustrative communication network 144 includes, without limitation, a Wide Area Network (WAN), such as the Internet, a Local Area Network (LAN), a Personal Area Network (PAN), a Public Switched Telephone Network (PSTN), a Plain Old Telephone Service (POTS) network, a cellular communications network, an IP Multimedia Subsystem (IMS) network, a Voice over IP (VoIP) network, a SIP network, or combinations thereof. The Internet is an example of the communication network 144 that constitutes an Internet Protocol (IP) network including many computers, computing networks, and other communication devices located all over the world, which are connected through many telephone systems and other means. In one configuration, the communication network 144 is a public network supporting the TCP/IP suite of protocols. Communications supported by the communication network 144 include real-time, near-real-time, and non-real-time communications. For instance, the communication network 144 may support voice, video, text, web-conferencing, or any combination of media. Moreover, the communication network 144 may comprise a number of different communication media such as coaxial cable, copper cable/wire, fiber-optic cable, antennas for transmitting/receiving wireless messages, and combinations thereof. In addition, it can be appreciated that the communication network 144 need not be limited to any one network type, and instead may be comprised of a number of different networks and/or network types.

In some embodiments, the content server 148 and/or the client device 104 may include software and/or hardware for implementing a content store 172 and/or a video list generator 132, 176. As will be described later, in embodiments consistent with the present disclosure, the video list generator 132, 176 generates and/or selects a collection of videos corresponding to one or more paths through a series of nodes. Moreover, the content server 148 may cause to be displayed to a user interface 124 of a client device 104, one or more videos associated with one or more paths in the collection of paths, where the video may be provided by the content store 172 and in response to a selection of an image corresponding to a node.

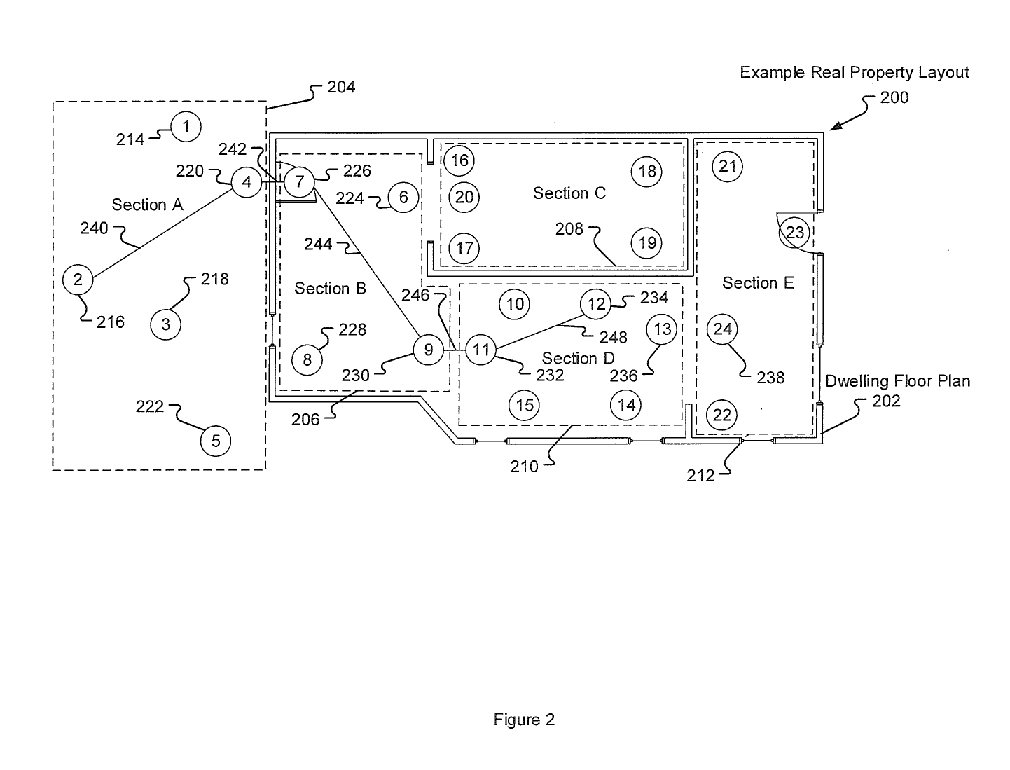

In accordance with some embodiments of the present disclosure, FIG. 2 illustrates an example real property layout 200, such as a floor plan 202 and/or plot plan of a dwelling. As shown, the example floor plan 202 and/or plot plan may be partitioned into one or more sections, such as Section A 204, Section B 206, Section C 208, Section D 210, and Section E 212; each section may correspond to one or more rooms, areas, or spaces of a plot plan or dwelling. For example, Section A 204 may correspond to the front area, such as a front yard, outside the dwelling; Section B 206 may correspond to a Living Room in the dwelling; Section C 208 may correspond to a Bedroom in the dwelling; Section D 210 may correspond to a Kitchen in the dwelling; and Section E 212 may correspond to a Family Room in the dwelling. Although Sections A 204 through Section E 212 are shown, it should be understood that additional or fewer sections may be provided in some embodiments. A collection of sections, such as Sections A 204 through Section E 212 may comprise or otherwise correspond to a map of the floor plan 202.

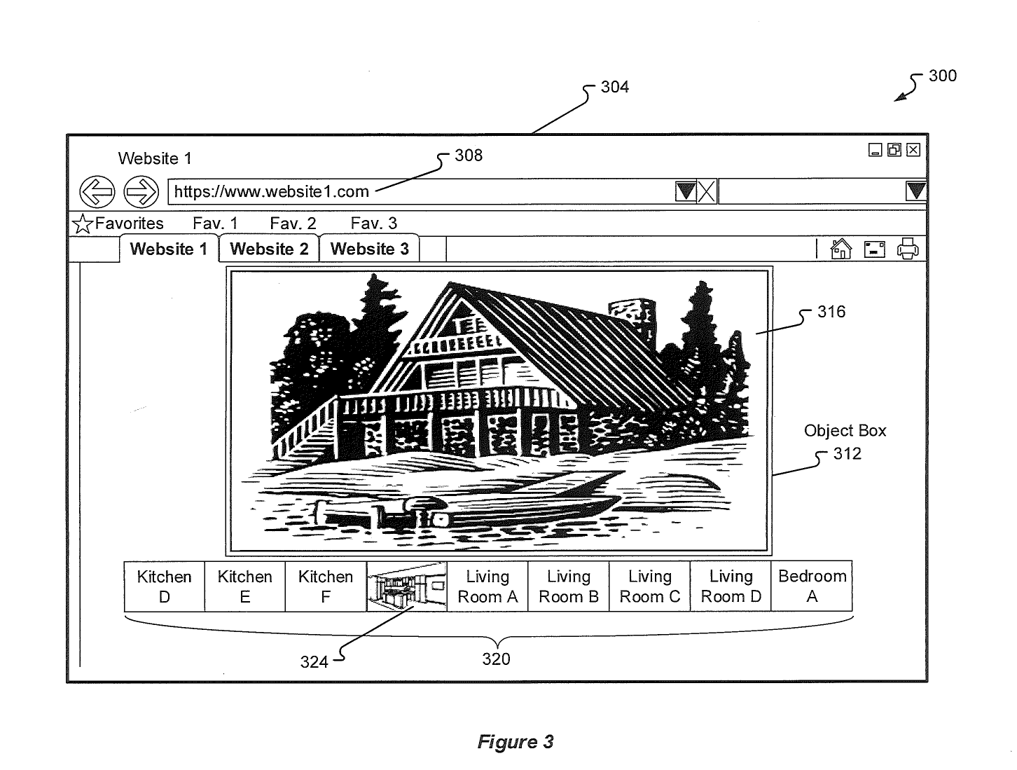

In accordance with some embodiments, each section includes one or more nodes. Nodes may be unique positions within a section and may connect two sections together. As shown in FIG. 2, nodes are illustrated as circles having an identifier, such as a number inside the circle. For example, as illustrated in FIG. 2, Section A 204 includes node 1 214, node 2 216, node 3 218, node 4 220, and node 5 222. Section B 206 includes node 6 224, node 7 226, node 8 228, and node 9 230. Transition nodes may be nodes that connect two sections together. For example and as illustrated in FIG. 2 and in FIG. 3, node 4 220 and node 7 226 are transition nodes, as these nodes connect Section A 204 and Section B 206 together. As another example, node 13 236 and node 24 238 are transition nodes, as these nodes connect Section D 210 and Section E 212 together. Of course, each section may include additional or fewer nodes.

In accordance with some embodiments of the present disclosure, a path may be a track between two nodes in a section and may comprise a start node (e.g. current node) and a finish node (e.g. end node). As one non-limiting example, a path 240 may exist between node 2 216 and node 4 220; a path may exist between node 4 220 and node 1 214, a path may exist between node 1 214 and node 4 220, a path may exist between node 3 218 and node 5 222; and a path may exist between node 5 222 and node 2 216. In general, a path may be between each node in a section and may be unidirectional or bidirectional. Additionally, a path may be a track between two transition nodes. For example, a path 242 may exist between node 4 220 and node 7 226; and a path 242 may exist between node 9 230 and node 11 232.

In some embodiments, each node may be associated with one or more images or pictures associated with the property, where the one or more images may be stored in and accessible from the content store 172 of the content server 148. For instance, such an image may result from a photographer recording an image at a particular node, such as node 1 214. Additionally, each image may be named according to a predetermined nomenclature identifying or otherwise associating the image to a particular node. For example, the image may be named Node_1. Further, the images may comprise high resolution images (e.g. having a resolution above or higher than that of the video) and may be stored in a variety of formats, such as, but not limited to, .jpeg, .gif, .raw, .png, .bmp, .rgbe, and .iff-rgfx,

Additionally, each path may be associated with one or more videos, where the one or more videos may be stored in and accessible from the content store of the content server. For example, a path comprising a start node of node 1 214 and end node of node 3 218 may have a corresponding video illustrating the path taken from node 1 214 to node 3 218. For instance, such a video may result from a videographer recording video while walking or otherwise moving from node 1 214 to node 3 218. Additionally, such a video may include information identifying the corresponding path; for example, the video may be named Node_1_to_Node_3, or include metadata describing the path and/or other information relating to the video. Furthermore, such video may be recorded and/or stored in a variety of video formats. The video may include video acquired from a single viewpoint, video acquired from multiple viewpoints, two-dimensional video, three-dimensional video, 360 degree videos, and the like. Additionally, storage formats may include, but are not limited to: mp4, .avi, .mov, .movi, .flv, .mpeg, .mpg, and .vid.

Referring now to FIG. 3, an illustrative embodiment of a user interface 300 for a virtual tour system 100 will be described in accordance with at least some embodiments of the present disclosure. The user interface 300 may be displayed in a web browser 304, such as the web browser depicted in FIG. 3; such a web browser may be directed to a web address, or Uniform Resource Locator (URL) 308 that is associated with a resource that provides content form a content server 148. For example, the URL 308 may be directed to web server other than the content server 148; however, in some embodiments, the URL 308 may identify, or otherwise be associated with, the address and/or location of the content server 148. Alternatively, or in addition, the user interface 300 may comprise a native application running on a local computer, such as client device 104. While a general description and depiction of the user interface 300 is illustrated in FIG. 3, the example user interface of FIG. 3 may include more or fewer displays, elements, or the placement of elements may be arranged differently than those shown in FIG. 3. The depiction of the user interface 300 in FIG. 3 assumes that a display can be created for a set of computer-executable instructions executed by a computer system and encoded or stored on a non-transitory computer readable medium, additionally requiring an external monitor or other display. Further, the user interface 300 may be the same as or similar to the user interface 124. That is, the client device may generate the user interface 124, 300.

The user interface 300 may include a larger window or object box 312 displaying an image 316 associated with a property in the display and additional smaller images 320 (e.g. thumbnails) associated with the property around or adjacent to the larger window or object box 312. Thus, when a user desires to view an image in the larger window or object box 312 of the display, the user selects a thumbnail image, such as thumbnail image 324, from the displayed thumbnails 320. In doing so, the client device 104 and/or the content server 148 may proceed to transition from displaying a currently displayed image 316 located in the object box 312 to displaying an image associated with the selected thumbnail image, such as thumbnail image 324. Such a transition may include hiding or otherwise removing the currently displayed image 316 in the object box, displaying one or more videos, and then displaying or otherwise showing an image associated with the selected thumbnail image 324. Of course, the object box 312 illustrated in FIG. 3 may be associated with each image and each video independently, or the same object box 324 may be set to show or otherwise display the current image 316, an image associated with the selected thumbnail image (e.g. 324), and the one or more videos accordingly.

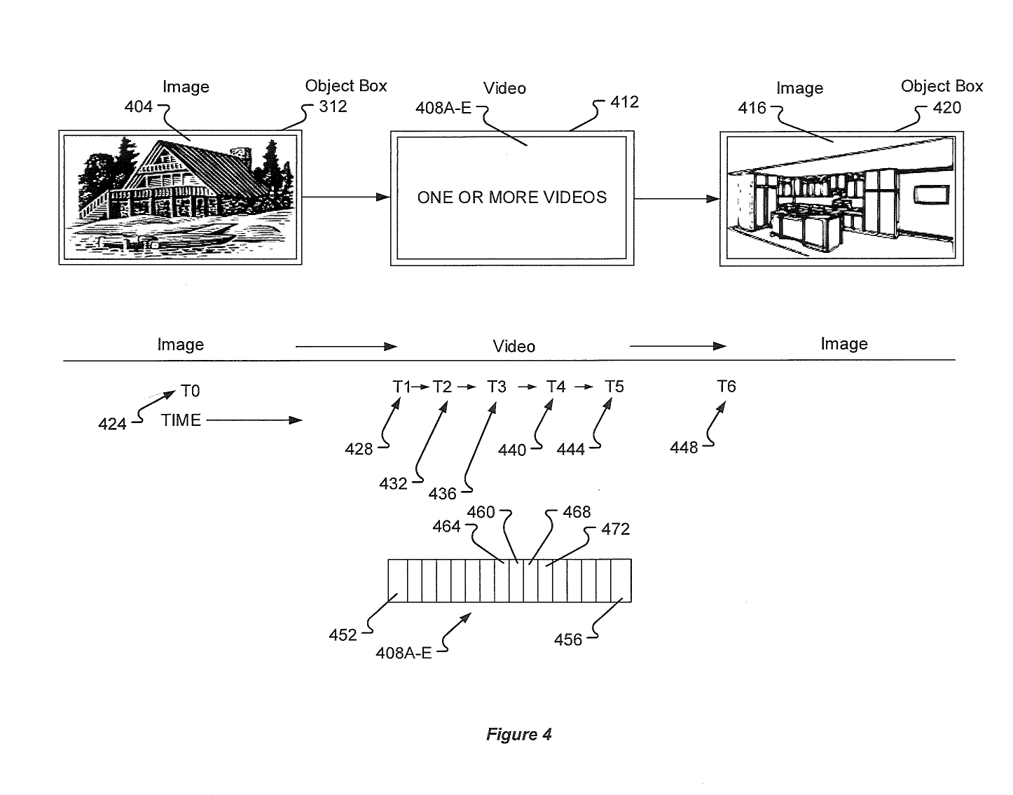

FIG. 4 displays the contents of an object box 312 illustrated in FIG. 3 over time. For example, a current image 404 associated with node 2 216 may be displayed or otherwise shown in the object box 312 at a time equal to T0 424. For instance, node 2 216 may be located at the front of a particular property and the resulting image may display at least one perspective of the property; in this instance, a side of a house is displayed. If, for example, a user selects a thumbnail associated with a kitchen image (e.g. node 12), a list of videos corresponding to a collection of paths may be generated by the video list generator 132, 176; such a list may include one or more videos corresponding to a trail, or a collection of paths, between node 2 216 and node 12 234. Thus, the image 404 displayed at T0 424 may be hidden and/or the object box 404 may be hidden.

At time equal to T1 428, one or more videos 408A-E associated with a collection of paths may then be displayed in an object box 412. In some instances, only one video may be utilized where a path exists between a current node and a user selected image corresponding to an end node. The object box 412 may be the same or similar to object box 312. Alternatively, or in addition the object box 412 is different than the object 312. For example, object box 312 may no longer be displayed at the user interface 300; however, object box 412 may be a new object box and may be displayed instead. At T1 428, a first video 408A associated with a path 240 between node 2 216 and node 4 220 may be displayed; at T2 432, a second video 408B associated with a path 242 between node 4 220 and node 7 226 may be displayed; at T3 436, third video 408C associated with a path 244 between node 7 226 and node 9 230 may be displayed; at T4 440, a fourth video 408D associated with a path 246 between node 9 230 and node 11 232 may be displayed; and at T5 444, a fifth video 408E associated with a path 248 between node 11 232 and node 12 234 may be displayed. At T6 448, an image, such as image 416, associated with the thumbnail 324 selected by the user is then displayed in an object box 420. The object box 420 may be the same or similar to object box 312 and/or object box 412. Alternatively, or in addition the object box 420 is different than the object 312 and/or the object box 412. For example, object box 412 may no longer be displayed at the user interface 300; however, object box 420 may be a new object box and may be displayed instead. Accordingly, the object box responsible for displaying the images and the one or more videos may be the same object box (for example, the source of the object box changes) or a new object box that is dynamically created for each video and/or each image.

In addition, the first currently displayed image 404 may generally be associated with a first node in the collection of paths generated by the video list generator 132, 176; accordingly, the first frame 452 or image of the first video 408A displayed in the object box 412 may correspond to the currently displayed image 404 in the object box 312. For instance, the first frame 452 of the first video 408A displayed at T1 428 may correspond to or otherwise match the image 404 shown or displayed at T0 424. By matching the image 404 displayed at T0 424 to the first frame 452 of the video 408A shown at T1 428, a smooth transition from image 404 to video 408A may be realized.

Similarly, the image associated with a thumbnail selected by a user is generally associated with the last node in the collection of paths generated by the video list generator 132, 176; therefore, the last frame 456 or image of the last video 408E displayed in the object box 420 may correspond to the image associated with a thumbnail 324 selected by the user. For instance, the last frame 456 of the video displayed at T5 444 may correspond to or otherwise match the image 416 associated with a thumbnail 324 selected by a user shown or displayed at T6 448. By matching the image 416 displayed at T6 448 to the last frame 456 of the video shown at T5 444, a smooth transition from video to the image may be realized.

Transitioning between an image and video and transitioning between video and an image may be desired to realize certain efficiencies. For example, the image 404 displayed at T0 424 and the image 416 displayed at T6 448 may comprise a higher resolution than the resolution of the video 408A-E displayed at T1-T5 428-444. Alternatively, or in addition, the image 404 displayed at T0 424 and the image 416 displayed at T6 448 may comprise a lower resolution than the resolution of the video 408A-E displayed at T1-T5 428-444. Alternatively, or in addition, the image 404 displayed at T0 424 and the image 416 displayed at T6 448 may comprise the same resolution as the resolution of the video 408A-E displayed at T1-T5 428-444. Additionally, it should be appreciated that one or more of the images displayed to a user may be displayed at a resolution that is different than, or not the same as, that of the video presented to the user. Thus, the resolution and size of the different media types may be situation dependent and may be adjustable based on bandwidth, subscription, and/or other parameters. Moreover, the resolution of the images and the resolution of the videos may be dynamically adjustable.

In some embodiments, an image may be displayed between the one or more videos 408A-E. For example, at time equal to T1 428, one or more videos 408A-E associated with a collection of paths may be displayed in an object box 412. At T1 428, a first video 408A associated with a path 240 between node 2 216 and node 4 220 may be displayed. Prior to displaying a second video 408B at T2 432, an image may be displayed in the object box. The object box may be the same object box in which the video 408A was displayed in, or the object box may be different. As one example, an image 460 matching or otherwise corresponding to a last frame 464 of the video 408A may be displayed. Moreover, an image 468 may be displayed that matches or otherwise corresponds to the first frame 472 of another video, such as video 408B. Images 460 and 468 may correspond to a particular node existing between a path from a first node to a last node. Similar to image 448, images 460 and 468 may be of a different resolution than the video displayed before them.

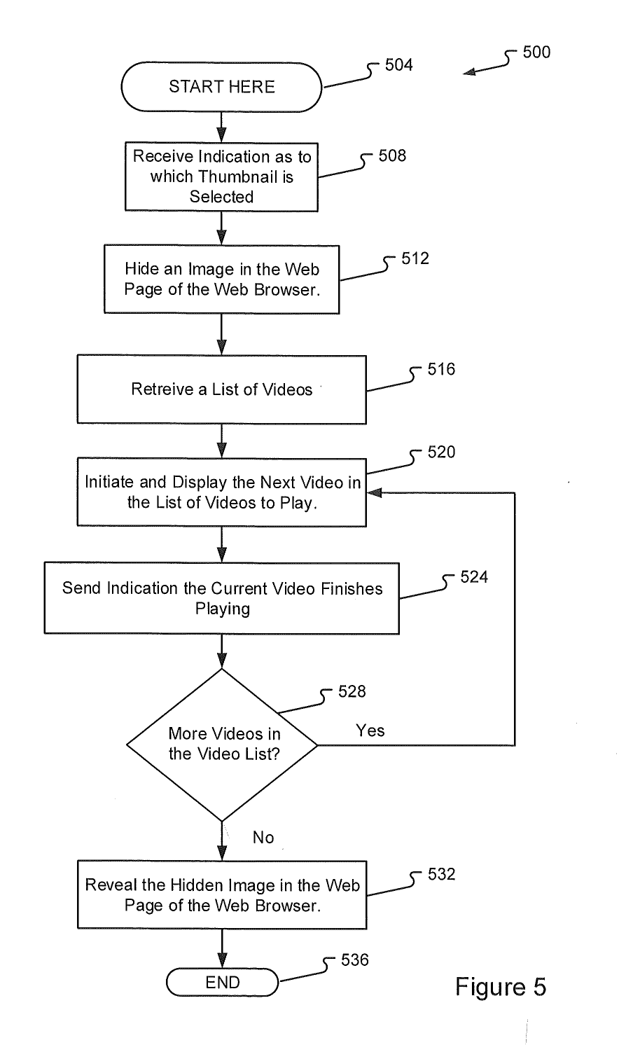

Referring now to FIG. 5, a method 500 of presenting a series of videos in response to a selection of a picture will be discussed in accordance with embodiments of the present disclosure. This method is in embodiments, performed by a device, such as a content server 148 and/or a client device 104. More specifically, one or more hardware and software components may be involved in performing this method. For example, the server application 168, content store 172 of the content server 148 and/or the client application 128 may perform one or more steps of the described method. The method 500 may be executed as a set of computer-executable instructions executed by a computer system and encoded or stored on a computer-readable medium. Hereinafter, the method 500 shall be explained with reference to systems, components, modules, software, etc. described with FIGS. 1-4.

The method of presenting a series of videos in response to a selection of a picture may continuously flow in a loop, flow according to a timed event, or flow according to a change in an operating or status parameter. The method may be initiated at step 504 where a client device 104 and/or content server 148 may initiate the display of a current image, such as an image 316, 404. For example, the content server 148 may cause a current image to be displayed at an output device, such as user output 120, associated with the client device 104. That is, the content server 148 may provide a current image file, such as a file containing image 316, 404 to the client device 104. The content server 148 may also provide additional information to the client device 104. For example, the content server 148 may also provide or serve web pages containing html or other code to the client device 104. Alternatively, or in addition, a separate web server may provide such information to the client device 104. The client device 104 may then generate a user interface 124 such that the user interface 124 is output to a device associated with user output 120, such as a display. Thus, an image 316, such as a first image, may be displayed in an object box 312. The method may then proceed to step 508, where a user selects a second image to be displayed. For example, the user may select a thumbnail image, such as thumbnail image 324, corresponding to a specific node 234 and the image to be displayed, or a third image, may be a larger version and/or higher resolution image associated with the selected thumbnail and the specific node. Additionally, the content server 148 may then receive a request, or an indication, from the client device 104 indicating that the user desires to view the image associated with a specific node, such as node 234.

The method 500 then proceeds to step 512, where the image currently displayed is hidden. For example, the currently displayed image may be displayed in an object box located within a webpage of a web browser. The currently displayed image 316, 404 may be hidden in a variety of different manners. As one example, the image itself 316, 404 may be hidden, the object box, such as object box 312, may be moved behind another object box, such as object box 412, and/or the object box 412 may function in accordance with a new image and/or media source parameter and/or value. Once the image is hidden, the method then proceeds to step 516 where a list of videos (e.g. movies) is retrieved. In some embodiments, a list of videos to be displayed between two nodes may already exist. Alternatively, or in addition, the list of videos to be displayed be created or generated based on a starting node, for example node 2 216, and an ending node, for example node 12 234. The list of videos may correspond to videos, or files of one or more videos, for each path between the starting and ending nodes. As previously discussed, the list of videos may be created by the video list generator 176 located in the content server 148 and/or in the video list generator 132 located on the client device 104 and may include one or more videos corresponding to a trail, or a collection of paths, between two nodes. The method then proceeds to step 520 where a video (e.g. movie) in the previously retrieved list is displayed, and/or played. In one example, the video to be played or displayed to a user may be transferred from the content store 172 as a single video file. Alternatively, or in addition, multiple videos to be played or displayed to a user may be transferred from the content store 172 as one or more video files.

Accordingly, the object box 412 may present to a user, via a user interface, a first movie 408A in the list, where the list may include videos 408A, 408B, 408C, 408D, and 408E. Once the first video 408A finishes playing, the method determines if there are additional movies to be displayed in steps 520 and 528. If there are additional videos in the list, the method proceeds to step 520 where the next video in the list of videos is played. For example, if multiple videos were transferred from the content store 172 to the client device 104, the client application 128 may determine which, if any, additional videos are to be displayed. If, however, no additional videos are in the list, the method proceeds to step 532 where an image, such as image 416, associated with a picture 324 selected by the user is revealed. In some embodiments, the file containing the data of the image 416 may be transferred from the content store 172 to the client device. The image may be transferred at any point throughout the method 500 at or before step 532. Accordingly, the image 416 itself may be revealed such that it is no longer hidden, the object box may be moved in front of another object box, and/or the object box may function in accordance with a new image and/or media source parameter and/or value. The method may then end at step 536. Further, it is contemplated that method 500 may repeat again. For instance, the image displayed at time equal to T0 424, such as image 416, may be referred to as the first image; a user may select a second image, or thumbnail image corresponding to a location, or node, in which the user wishes to view, a series of videos may be displayed between time equal to T1 428 and time equal to T5 444, and a third image corresponding to the selected thumbnail image may then be displayed at time equal to T6 448.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A method for presenting a series of videos to a user, the method comprising:
displaying a first image;
receiving an indication associated with a selection of a second image to be displayed;
displaying one or more videos based upon the received indication; and
displaying a third image associated with the second image after the one or more videos have been displayed.

2. The method of claim 1, wherein a first frame of the one or more videos corresponds to the first image and a last frame of the one or move videos corresponds to the third image.

3. The method of claim 2, wherein the one or more videos correspond to a series of paths existing between a first node associated with the first image, and a second node associated with the third image.

4. The method of claim 3, wherein at least one of the first image and the third image have a resolution that is higher than at least one of a resolution of the first frame and the second frame.

5. The method of claim 3, wherein the second image is a thumbnail image corresponding to the third image.

6. The method of claim 3, further comprising generating a list containing the one or more videos, wherein each video within the list containing the one or more videos corresponds to a path existing between the first node and the second node.

7. The method of claim 1, further comprising:
receiving a second indication associated with a selection of a fourth image to be displayed;
displaying at least one video based upon the received second indication, wherein the at least one video is different from the previously displayed one or more videos; and
displaying a fifth image associated with the fourth image after the one or more videos have been displayed.

8. A computer readable storage medium comprising processor executable instructions operable to perform the method of claim 1.

9. A method for presenting a series of videos to a user, the method comprising:
providing a first image to a client device;
receiving an indication associated with a selection of a second image to be displayed;
generating a list containing one or more videos, wherein each video within the list containing the one or more videos corresponds to a path existing between a first node associated with the first image and a second node associated with the second image;
providing the one or more videos to the client device based upon the generated list; and
providing a third image corresponding to the second image to the client device.

10. The method of claim 9, wherein a first frame of the one or more videos corresponds to the first image and a last frame of the one or move videos corresponds to the third image.

11. The method of claim 10, wherein at least one of the first image and the third image have a resolution that is higher than at least one of a resolution of the first frame and the second frame.

12. The method of claim 11, wherein the first image, the one or more videos, and the third image are different files.

13. A computer readable storage medium comprising processor executable instructions operable to perform the method of claim 9.

14. A system for presenting a series of videos to a user, the system comprising:
a device including:
a communication interface;
a processor;
data storage; and
a client application stored on the data storage, wherein the client application includes instructions that when executed by the processor, are operable to present a first image and a plurality of thumbnail images at a user output device, wherein the client application is operable to receive an indication associated with a selection of a first thumbnail image, wherein the client application is operable to display one or more videos corresponding to the received indication, and wherein the client application is operable to display a second image, wherein the second image is a larger image corresponding to the first thumbnail image.

15. The system of claim 14, further comprising:
a content server including:
a communication interface;
a processor;
data storage; and
a server application stored on the data storage, wherein the server application includes instructions that when executed by the processor of the content server, are operable to provide the first image and the plurality of thumbnail images to the device utilizing the communication interface of the content server and the communication interface of the device, and wherein the server application is operable to receive the selection of the first thumbnail image, and provide the one or more videos and the second image to the client based on the received indication.

16. The system of claim 15, wherein the server application is operable to generate a list containing the one or more videos, wherein each video within the list containing the one or more videos corresponds to a path existing between a first node associated with the first image and a second node associated with the second image.

17. The system of claim 14, wherein the client application is operable to generate a list containing the one or more videos, wherein each video within the list containing the one or more videos corresponds to a path existing between a first node associated with the first image and a second node associated with the second image.

18. The system of claim 14, wherein a first frame of the one or more videos corresponds to the first image and a last frame of the one or move videos corresponds to the second image.

19. The system of claim 18, wherein the one or more videos correspond to a series of paths existing between a first node associated with the first image and a second node associated with the second image.

20. The system of claim 18, wherein at least one of the first image and the second image have a resolution that is higher than at least one of a resolution of the first frame and the second frame.
